(19) United States
(12) Patent Application Publication
(10) Pub. No.: US 2017/0090832 A1
(43) Pub. Date: Mar. 30, 2017

(54) INFORMATION PROCESSING DEVICE, INFORMATION PROCESSING METHOD, AND NON-TRANSITORY COMPUTER-READABLE MEDIUM

(71) Applicant: FUJI XEROX CO., LTD., Tokyo (JP)

(72) Inventor: Tomohiro ISHIBASHI, Kanagawa (JP)

(73) Assignee: FUJI XEROX CO., LTD., Tokyo (JP)

(21) Appl. No.: 15/014,425

(22) Filed: Feb. 3, 2016

(30) Foreign Application Priority Data
Sep. 24, 2015 (JP) 2015-187398

(51) Int. Cl. G06F 3/12

(52) U.S. Cl. CPC G06F 3/1222; G06F 3/1238; G06F 3/1286

(57) ABSTRACT

An information processing device includes a process execution unit that executes a process, a generation unit that, in response to a login request from a user, generates login session information that becomes invalid if the user logs out, and a control unit. If user identification information assigned to a user who specified the execution of the process is unique user identification information that is unique to the user, the control unit controls a user operation on the process with the unique user identification information. If user identification information assigned to a user who specified the execution of the process is shared user identification information that is shared among multiple users, the control unit controls a user operation on the process with the login session information.

### CROSS-REFERENCE TO RELATED APPLICATIONS

This application is based on and claims priority under 35 USC 119 from Japanese Patent Application No. 2015-187398 filed Sep. 24, 2015.

### BACKGROUND

### Technical Field

The present invention relates to an information processing device, an information processing method, and a non-transitory computer-readable medium.

### SUMMARY

According to an aspect of the invention, there is provided an information processing device that includes a process execution unit that executes a process, a generation unit that, in response to a login request from a user, generates login session information that becomes invalid if the user logs out, and a control unit. If user identification information assigned to a user who specified the execution of the process is unique user identification information that is unique to the user, the control unit controls a user operation on the process with the unique user identification information. If user identification information assigned to a user who specified the execution of the process is shared user identification information that is shared among multiple users, the control unit controls a user operation on the process with the login session information.

### BRIEF DESCRIPTION OF THE DRAWINGS

An exemplary embodiment of the present invention will be described in detail based on the following figures, wherein:

FIG. 1 is a block diagram illustrating an image forming system according to an exemplary embodiment of the present invention;

FIG. 2 is a block diagram illustrating an image forming device according to an exemplary embodiment;

FIG. 3 is a block diagram illustrating a terminal device;

FIG. 4 illustrates an example of accounts;

FIG. 5 is a flowchart illustrating an example of a process during job execution;

FIG. 6 is a flowchart illustrating an example of a process during user identification;

FIG. 7 is a flowchart illustrating an example of a login session validity determination process;

FIG. 8 is a flowchart illustrating an example of a login session information alteration process;

FIG. 9 is a flowchart illustrating an example of a process when a login session is invalid;

FIG. 10 is a table for explaining a specific example 1;

FIG. 11 is a flowchart illustrating a process according to a specific example 2;

FIG. 12 is a flowchart illustrating a process according to a specific example 3; and

FIG. 13 is a flowchart illustrating a process according to a specific example 4.

### DETAILED DESCRIPTION

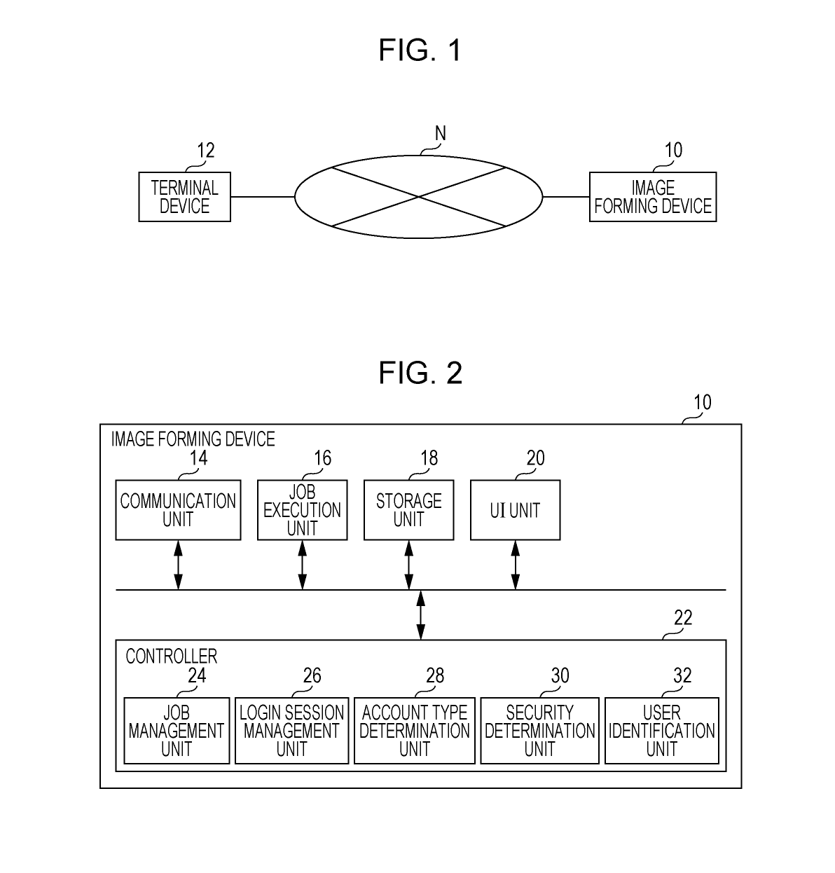

FIG. 1 illustrates an example of an image forming system as an information processing system according to an exemplary embodiment of the present invention. The image forming system includes an image forming device 10 and a terminal device 12 as information processing devices, for example. The image forming device 10 and the terminal device 12 is connected to a communication link N such as a network. Multiple image forming devices 10 and multiple terminal devices 12 may also be included in the image forming system.

The image forming device 10 is equipped with at least function from among a scan function, a print function, a copy function, and facsimile function, for example. In addition, the image forming device 10 is equipped with a function of transmitting and receiving data to and from other devices. Hereinafter, a process executed by the image forming device 10 will be designated a “job”.

The terminal device 12 is a device such as a personal computer (PC), a tablet PC, a smartphone, or a mobile phone, and is equipped with a function of transmitting and receiving data to and from other devices. The terminal device 12 is used by a user during the execution of a job, for example.

Hereinafter, a configuration of the image forming device 10 will be described in detail with reference to FIG. 2. FIG. 2 illustrates a configuration of the image forming device 10.

The communication unit 14 is a communication interface, and is equipped with a function of transmitting data to other devices, and a function of receiving data from other devices. For example, with the communication unit 14, information such as job-related information and user authentication information is received.

The job execution unit 16 is equipped with a function of executing a job. A job may be an image processing process, a scan process, a print process, a copy process, or a facsimile process, for example. An image processing process may be a process of extracting differences from an image or a character recognition process, for example. A scan process is a process of generating document data by scanning an image of an original. A print process is a process of printing a document. A copy process is a process of duplicating a document. A facsimile process is a process of transmitting or receiving a document by facsimile communication. For example, document data may be generated by executing a scan process, and the document data may be transmitted to an external device. As another example, by executing a print process, document data stored in the image forming device 10 may be printed.

The storage unit 18 is a storage device such as a hard disk. Job information for executing jobs is stored in the storage unit 18. Job information includes, as settings information, information such as the parameters of the job, information indicating the storage location of resulting data generated by the execution of the job, information for specifying data on which to apply image processing, and user identification information (for example, a user ID or a user name) for identifying the user who specified the execution of the job. In addition, resulting data generated by the execution of the job is stored in the storage unit 18.

The UI unit 20 is a user interface including a display unit and an operating unit. The display unit is a display device such as a liquid crystal display, for example. The operating unit is an input device such as a touch panel or a keyboard, for example.

The controller 22 is equipped with a function of controlling the operation of each component of the image forming device 10. In addition, the controller 22 includes a job management unit 24, a login session management unit 26, an account type determination unit 28, a security determination unit 30, and a user identification unit 32.

The job management unit 24 is equipped with a function of managing jobs. For example, the job management unit 24 adds information such as account information and security information discussed later to the job information.

When a user logs in to the image forming device 10, the login session management unit 26 generates login session information for identifying the login session (for example, a login session ID). The login session (login session information) is valid while the user is logged in, but becomes invalid if the user logs out. In other words, when login occurs, a login session is established between the user or terminal device 12 and the image forming device 10, and that login session is discarded when logout occurs. The login session management unit 26 generates different login session information for each login, and associates login session information with each logged-in user. Consequently, login sessions established by individual logins are distinguished by the login session information, and individual login statuses (login sessions), or in other words, individual users, are identified. In the present exemplary embodiment, a login to the image forming device 10 is realized by using either unique account information as individual user identification information, or shared account information as shared user identification information. Unique account information is user identification information for identifying individual users (for example, a unique account ID and password). Unique account information is user identification information that is unique to each user, and is created in advance for individual users and given to each user. By using unique account information, individual users are distinguished and identified. Shared account information is user identification information shared in common among multiple users (for example, a shared account ID and password). Shared account information is created in advance and given to users. By using shared account information, individual users are indiscriminately identified without being distinguished. Whether the account information used for login is unique account information or shared account information, the login session management unit 26 generates login session information.

The account type determination unit 28 is equipped with a function of determining the type of account assigned to a user. For example, the account type determination unit 28 determines the account type during login to the image forming device 10 or during the execution of a job. Either unique account information or shared account information is used for login, and the account type determination unit 28 determines the type of that account information.

The security determination unit 30 is equipped with a function of determining the security level of a job (application) to be executed. For example, information indicating a correspondence relationship between the content of a job and the security level is created in advance and stored in the storage unit 18. By referencing this information, the security determination unit 30 determines the security level of the job to be executed. In addition, the security determination unit 30 may also determine the security level of data that is the target of a job. The security level of data is user-decided, for example. Information indicating the security level of data is associated with the data in advance, for example. By referencing this information, the security determination unit 30 determines the security level of the data. Security information indicating the security level of a job or data is added to the job information.

In addition, the security determination unit 30 may also determine the security level of an intervention event occurring during the execution of a job. An intervention event may be, for example, a pause request by the user, a preview confirmation conducted during processing, a confirmation of the name of the save data, a confirmation of the data save location, an authentication process, an operation with respect to the job, a setting of access rights to resulting data, an out-of-paper error, or an out-of-toner error. If an intervention event occurs during the execution of a job, the job stops. By executing an intervention operation, the intervention event is resolved. An intervention operation may be, for example, unpausing a paused job, a preview confirmation operation, an operation to modify the name of the save data, an operation to modify the data save location, an input of authentication information, an operation of setting access rights to resulting data, resupplying paper, or resupplying toner. For example, information indicating a correspondence relationship between the intervention event and the security level is created in advance and stored in the storage unit 18. By referencing this information, the security determination unit 30 determines the security level of an intervention event that has occurred.

The user identification unit 32 is equipped with a function of identifying the user using any of unique account information, shared account information, and login session information when user identification is involved. For example, user identification is involved when an intervention event occurs. For example, if the account information assigned to the user who specified the execution of a job is unique account information, the user identification unit 32 identifies the user by the unique account information, whereas if the account information assigned to the user is shared account information, the user identification unit 32 identifies the user by either the shared account information or the login session information, according to the security level of the job (application), data, or the content of an intervention event.

The controller 22 denies or allows user operations on a job or resulting data, for example, according to the identification result from the user identification unit 32.

In addition, the user identification unit 32 identifies the user at the time of login to the image forming device 10. At the time of login, the user identification unit 32 receives either unique account information or shared account information as the account information, and identifies the user using the account information. Account information is stored in the storage unit 18, for example. Obviously, account information may also be stored in an external device. The user identification unit 32, upon receiving account information at the time of login, conducts an authentication process using the account information stored in the storage unit 18 or an external device, and the received account information. If account information corresponding to the account information received by the user identification unit 32 (for example, the same account information) is stored in the storage unit 18 or an external device, authentication is successful, and login is granted. If account information corresponding to the account information received by the user identification unit 32 is not stored in the storage unit 18 or an external device, authentication is unsuccessful, and login is denied.

The login operation may be performed by using the UI unit 20 or by using the terminal device 12. If the login operation is performed by using the UI unit 20, the user uses the UI unit 20 to input account information. If the login operation is performed by using the terminal device 12, the user uses the terminal device 12 to input account information, and the account information is transmitted from the terminal device 12 to the image forming device 10.

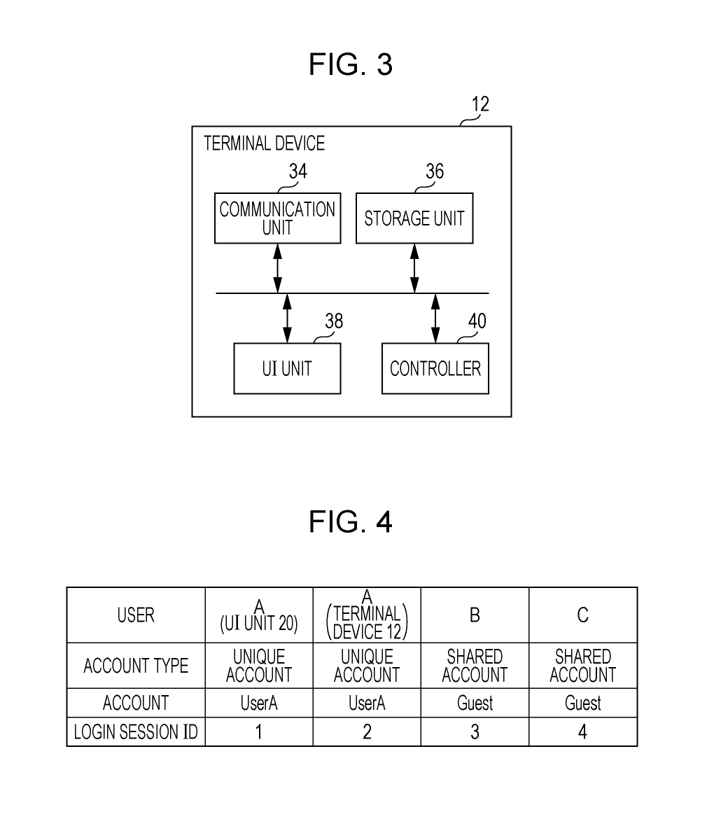

Hereinafter, a configuration of the terminal device 12 will be described in detail with reference to FIG. 3. FIG. 3 illustrates a configuration of the terminal device 12. The communication unit 34 is a communication interface, and is equipped with a function of transmitting data to other devices, and a function of receiving data from other devices. The storage unit 36 is a storage device such as a hard disk. The UI unit 38 is a user interface including a display unit and an operating unit. The display unit is a display device such as a liquid crystal display, for example. The operating unit is an input device such as a touch panel or a keyboard, for example. A controller 40 controls the operation of each component of the terminal device 12.

Hereinafter, accounts will be described with reference to FIG. 4. FIG. 4 illustrates an example of accounts.

Unique account information is assigned to a user A. The ID of the unique account is “UserA”. At the time of login by User A, the unique account information (for example, the unique account ID and a password) are used. For example, if User A uses the UI unit 20 to log in to the image forming device 10, the login session ID “1” is generated. Also, if User A uses the terminal device 12 to log in to the image forming device 10, the login session ID “2” is generated. User A is identified by the unique account information “UserA”.

Shared account information is assigned to Users B and C. The ID of the shared account is “Guest”. At the time of login by User B or C, the shared account information (for example, the shared account ID and a password) are used. For example, if User B uses the UI unit 20 or the terminal device 12 to log in to the image forming device 10, the login session ID “3” is generated, and if the user C uses the UI unit 20 or the terminal device 12 to log in to the image forming device 10, the login session ID “4” is generated. User B is identified by the shared account information or the login session ID “3”, and the user C is identified by the shared account information or the login session ID “4”. For example, Users B and C are identified by either the shared account information “Guest” or the login session ID, according to the security level of the job (application), data, or the content of an intervention event.

The login session ID (login session) of each user is valid while the relevant user is logged in to the image forming device 10, but becomes invalid when the relevant user logs out of the image forming device 10. For example, if User A uses the UI unit 20 to log out of the image forming device 10, the login session ID “1” becomes invalid, and the login session associated with login session ID “1” becomes invalid. Also, if User A uses the terminal device 12 to log out of the image forming device 10, the login session ID “2” becomes invalid, and the login session associated with login session ID “2” becomes invalid. The login session IDs (login sessions) of Users B and C are similar. In this way, login session IDs (login sessions) and users are associated uniquely, and if a user logs in again, a new login session is established, and a new login session ID for identifying the new login session is generated.

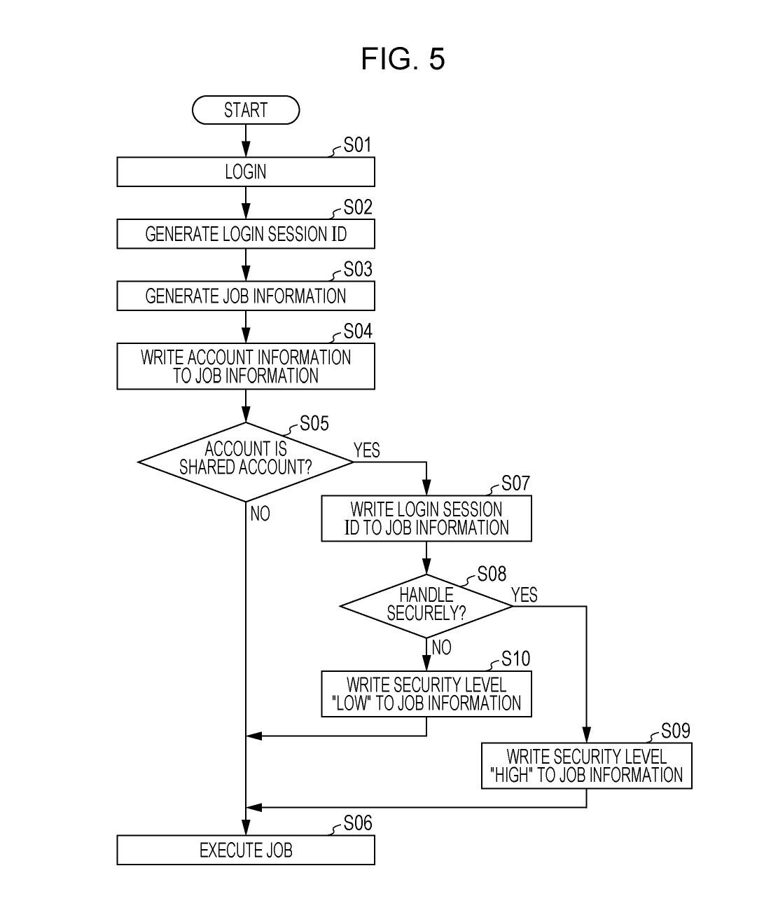

Hereinafter, a process during job execution will be described in detail with reference to FIG. 5. FIG. 5 illustrates a flowchart illustrating such a process. As an example, suppose that the UI unit 20 of the image forming device 10 is used to specify the execution of a job.

First, the user uses the UI unit 20 to input account information, and logs in to the image forming device 10 (S01). At this point, unique account information or shared account information is input by the user according to the account information assigned to the user. The user identification unit 32 conducts an authentication process using the input account information. If authentication is successful, login is granted, whereas if authentication is unsuccessful, login is denied.

If login is successful, the login session management unit 26 generates a login session ID for identifying that login session (S02).

Next, the user selects an application or the like, and specifies the execution of a job. The job management unit 24 generates job information for executing the application (S03). For example, an application selection screen is displayed on the UI unit 20, and the user selects an application on the screen. Additionally, the user inputs settings information including information such as the parameters of the application. Depending on the type of application, the user may also select data to process. The job management unit 24 generates job information including the settings or other information. Note that in the case of using the terminal device 12, the user selects an application or the like on the terminal device 12, and the job information is generated by the terminal device 12. The job information is transmitted from the terminal device 12 to the image forming device 10.

The job management unit 24 writes, to the job information, the account information of the user who specified the execution of the job to the job information (S04). If the account information is unique account information, unique account information is written to the job information. If the account information is shared account information, shared account information is written to the job information.

Next, the account type determination unit 28 references the account information included in the job information, and thereby determines the type of the account assigned to the user who specified the execution of the job (S05). If the account is a unique account (S05, No), the job execution unit 16 executes the job in accordance with the job information (S06).

If the account of the user is a shared account (S05, Yes), the job management unit 24 writes the login session ID to the job information (S07).

Next, the security determination unit 30 determines the security level (S08). For example, the security determination unit 30 determines the security level of the job (application) to be executed. For example, the security level is determined by referencing information indicating a correspondence relationship between the application and the security level. If the security level of the application is equal to or greater than a threshold value, the application is determined to be an application to handle securely, whereas if the security level is less than the threshold value, the application is determined to be an application not to handle securely. The threshold value is a preset value, for example. The threshold value may also be modified by a person such as the user or an administrator. For example, the copy process is an application that does not have to be handled securely.

If the application is an application to handle securely (S08, Yes), the job management unit 24 writes security information indicating a high security level to the job information (S09). If the application is not to be handled securely (S08, No), the job management unit 24 writes security information indicating a low security level to the job information (S10). Next, the job execution unit 16 executes the job in accordance with the job information (S06).

As another example, the security determination unit 30 may also determine a user-designated security level. For example, if the security level of data to be processed by the application has been set in advance by a user, the security determination unit 30 may determine the security level of that data. Information indicating the security level of the data is associated with the data, for example. By referencing this information, the security level is determined. If the security level of the data is equal to or greater than a threshold value, the data is determined to be data to handle securely, whereas if the security level is less than the threshold value, the data is determined to be data not to handle securely.

If the data is to be handled securely (S08, Yes), the job management unit 24 writes security information indicating a high security level to the job information (S09). If the data is not to be handled securely (S08, No), the job management unit 24 writes security information indicating a low security level to the job information (S10). Next, the job execution unit 16 executes the job in accordance with the job information.

Also, if the security level of the application is equal to or greater than a threshold value and the security level of the data is also equal to or greater than a threshold value, the security determination unit 30 may determine that the process is to be handled securely, and otherwise determine that the process is not to be handled securely. If it is determined that the process is to be handled securely, security information indicating a high security level is written to the job information. If it is determined that the process is not to be handled securely, security information indicating a low security level is written to the job information.

As another example, if the security level of one of either the application or the data is equal to or greater than a threshold value, the security determination unit 30 may determine that the process is to be handled securely, and otherwise determine that the process is not to be handled securely.

As yet another example, the user designation may be prioritized. In this case, the security determination unit 30 determines whether or not the process is to be handled securely according to the security level of the data, irrespectively of the security level of the application. Alternatively, the application setting may be prioritized. In this case, the security determination unit 30 determines whether or not the process is to be handled securely according to the security level of the application, irrespectively of the user designation.

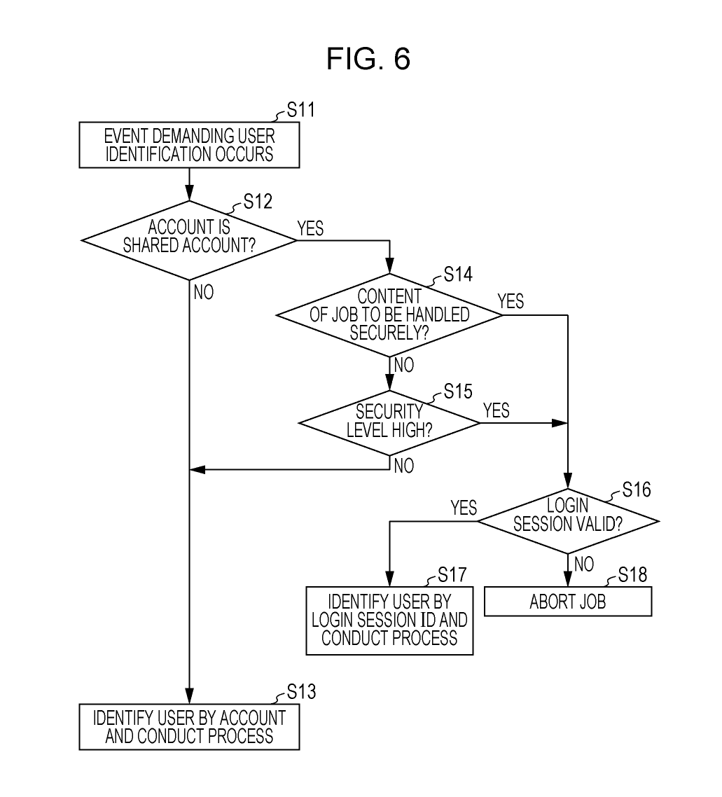

Hereinafter, a process when an event involving user identification occurs will be described in detail with reference to FIG. 6. FIG. 6 illustrates a flowchart illustrating such a process.

When an event demanding user identification (such as an intervention event, for example) occurs (S11), the account type determination unit 28 references the account information included in the job information, and thereby determines the type of the account assigned to the user who specified the execution of the job (S12). If the account is a not a shared account but rather a unique account (S12, No), the user identification unit 32 identifies the user by the unique account information (S13). For example, the user identification unit 32 compares unique account information included in the job information (the unique account information of the user who specified the execution of the job) to the account information of the user who performs an intervention operation. If the account information matches, the controller 22 allows the intervention operation, whereas if the account information does not match, the controller 22 denies the intervention operation.

For example, if the user who specified the execution of the job remains logged in to the image forming device 10, when an intervention operation is performed while in that login state (that is, during the login session established by the login), it is determined that the unique account information included in the job information matches the account information (unique account information) of the user who performs the intervention operation, and the intervention operation is allowed. Also, even if the user who specified the execution of the job logs out of the image forming device 10, if that user uses the same unique account information to log in to the image forming device 10 and perform the intervention operation, the unique account information included in the job information matches the account information (unique account information) of the user who performs the intervention operation, and the intervention operation is allowed. On the other hand, if another user uses shared account information to log in to the image forming device 10 and perform the intervention operation, the unique account information included in the job information and the account information (shared account information) of the user who performs the intervention operation do not match, and the intervention operation is denied. Also, if a user uses unique account information different from the unique account information included in the job information to log in to the image forming device 10 and perform the intervention operation, the unique account information included in the job information and the account information (unique account information) of the user who performs the intervention operation do not match, and the intervention operation is denied.

If the account assigned to the user who specified the execution of the job is a shared account (S12, Yes), the security determination unit 30 determines the security level of the content to be performed by the intervention operation (S14). For example, the security level is determined by referencing information indicating a correspondence relationship between the intervention event and the security level. If the security level of the intervention event is equal to or greater than a threshold value, the content to be performed by the intervention event is determined to be content to handle securely, whereas if the security level is less than the threshold value, the content to be performed by the intervention event is determined to be content not to handle securely.

For example, the security level of the content to be performed by the intervention event may change depending on factors such as the content of the intervention event, the cause of the intervention event, the range of effect of the intervention event, and the person having the authority to perform operations with respect to the intervention event.

For example, events in which the security level changes depending on the content and cause of the intervention event may be any of the following events.
Resulting data requiring secure handling is output.
Resulting data not requiring secure handling is output.
Resulting data is output to an external device, such as email transmission or the transmission of resulting data to an external server.
An event in which the result or output destination changes depending on the method of resolving the intervention event.

In addition, events in which the security level changes depending on the range of effect of the intervention event may be any of the following events.
The intervention event affects only the relevant job.
The intervention event affects subsequent jobs by shared account users.
The intervention event affects all subsequent jobs.

Also, a person having the authority to perform operations with respect to the intervention event may be any of the following persons.
The user who specified the execution of the job.
Shared account users.
All users.
An administrator.

If the intervention event is not to be handled securely (S14, No), the user identification unit 32 determines the security level by referencing the security information included in the job information (S15). If the security level is low (S15, No), the user identification unit 32 identifies the user by the shared account information (S13). For example, the user identification unit 32 compares the shared account information included in the job information to the account information of the user who performs the intervention operation. If the account information matches, the controller 22 allows the intervention operation, whereas if the account information does not match, the controller 22 denies the intervention operation.

For example, if a user uses shared account information to log in to the image forming device 10 and perform the intervention operation, the shared account information included in the job information and the account information (shared account information) of the user who performs the intervention operation match, and the intervention operation by that user is allowed.

If the intervention event is to be handled securely (S14, Yes), or if the security level indicated by the security information included in the job information is high (S15, Yes), the validity of the login session ID included in the job information, or in other words, the validity of the login session associated with that login session ID, is determined (S16). If the user who executed the job is logged in to the image forming device 10, the login session ID (login session) is valid, whereas if the user logs out of the image forming device 10, the login session ID (login session) becomes invalid.

If the login session ID (login session) included in the job information is valid (S16, Yes), the user identification unit 32 identifies the user by the login session ID (S17). The login session ID included in the job information being valid means that the user who specified the execution of the job is logged in to the image forming device 10. For example, the user identification unit 32 compares the login session ID included in the job information (the login session ID associated with the user who specified the execution of the job) to the login session ID associated with the user who performs the intervention operation. The controller 22 allows the intervention operation if the login session IDs match, and denies the intervention operation if the login session IDs do not match.

For example, if the login state associated with the login session ID included in the job information is maintained, when the intervention operation is performed while in that login state (in other words, during the login session established by that login), it is determined that the login session ID included in the job matches the login session ID of the user who performs the intervention operation, and the intervention operation is allowed. To describe using a specific example, if the login session ID included in the job information is “2”, and an intervention operation is performed while in a login state (login session) associated with “2” as the login session ID, it is determined that the login session ID included in the job information matches the login session ID of the user who performs the intervention operation, and the intervention operation is allowed.

On the other hand, when an intervention operation is performed while in a login state (login session) associated with a login session ID that differs from the login session ID included in the job information, it is determined that the login session ID included in the job information does not match the login session ID of the user who performs the intervention operation, and the intervention operation is denied. To describe using a specific example, if the login session ID included in the job information is “2”, and an intervention operation is performed while in a login state (login session) associated with “3” as the login session ID, it is determined that the login session ID included in the job information does not match the login session ID of the user who performs the intervention operation, and the intervention operation is denied. For example, if the user who specified the execution of the job logs out of the image forming device 10, and later logs in to the image forming device 10 again, the login session ID included in the job information becomes invalid, and a new login session ID that differs from the above login session ID is generated and associated with the user (login state). In this case, when an intervention operation is performed while in a login state (login session) associated with the new login session ID, it is determined that the login session ID included in the job information does not match the login session ID of the user who performs the intervention operation, and the intervention operation is denied. In this way, if the user logs out and the session is discarded, the intervention operation is denied, even if the user who performs the intervention operation and the user who specified the execution of the job are the same user.

If the login session ID included in the job information is not valid (S16, No), the controller 22 aborts the job (S18). In the case of aborting the job, the job information is deleted from the storage unit 18, for example.

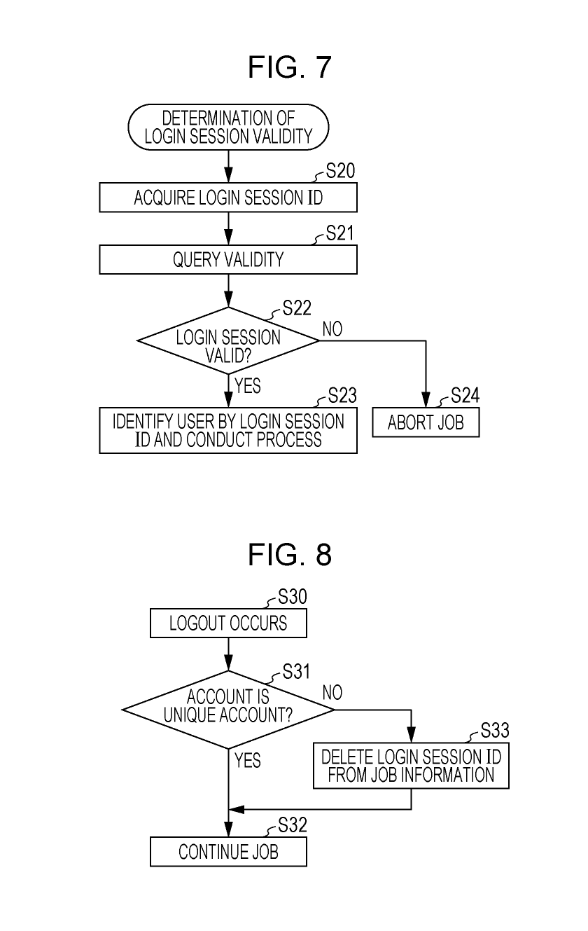

Hereinafter, a login session validity determination process will be described with reference to FIG. 7. FIG. 7 illustrates a flowchart illustrating such a process.

For example, the login session management unit 26 manages the validity of login sessions. If a user is logged in to the image forming device 10, the login session management unit 26 manages the login session (login session ID) by treating the login session established by that login as valid, and if the user logs out of the image forming device 10, the login session management unit 26 discards the login session (login session ID).

In the login session validity determination process, the user identification unit 32 acquires the login session ID from the job information (20), and queries the login session management unit 26 for the validity of the login session associated with that login session ID (S21). The login session management unit 26 determines the validity of the login session associated with the login session ID. If the login session is valid (S22, Yes), the user identification unit 32 identifies the user by the login session ID (S23). If the login session is not valid (S22, No), the controller 22 aborts the job (S24).

The validity of a login session may also be determined by another method. For example, when a login session becomes invalid, the login session information included in the job information may be altered, and validity may be determined on the basis of the alteration result.

Hereinafter, a login session information alteration process will be described with reference to FIG. 8. FIG. 8 illustrates a flowchart illustrating such a process.

If the user logs out of the image forming device 10 (S30), the account type determination unit 28 references the account information included in the job information to thereby determine the type of account of the user who specified the execution of the job (S31). If the account is a unique account (S31, Yes), the job execution unit 16 continues the job (S32). If the account is not a unique account (S31, No), or in other words, if the account is a shared account, the controller 22 deletes, from the job information, the login session ID corresponding to the login session in which the logout occurred (S33). After that, the job execution unit 16 continues the job (S32).

During the login session validity determination, the user identification unit 32 references the job information, and determines the validity of a login session ID (login session) according to whether or not the login session ID is included in the job information. If the login session ID is included in the job information, the login session ID (login session) is determined to be valid, whereas if the login session ID is not included in the job information, the login session ID (login session) is determined to be invalid.

Note that, as another method, validity information indicating the validity of a login session may be added to the job information. If a login session is valid, the controller 22 sets the content indicating the validity information to “true”, whereas if the login session is invalid, the controller 22 alters the content indicating the validity information from “true” to “false”. If the validity information indicates “true”, the login session is determined to be valid, whereas if the validity information indicates “false”, the login session is determined to be invalid.

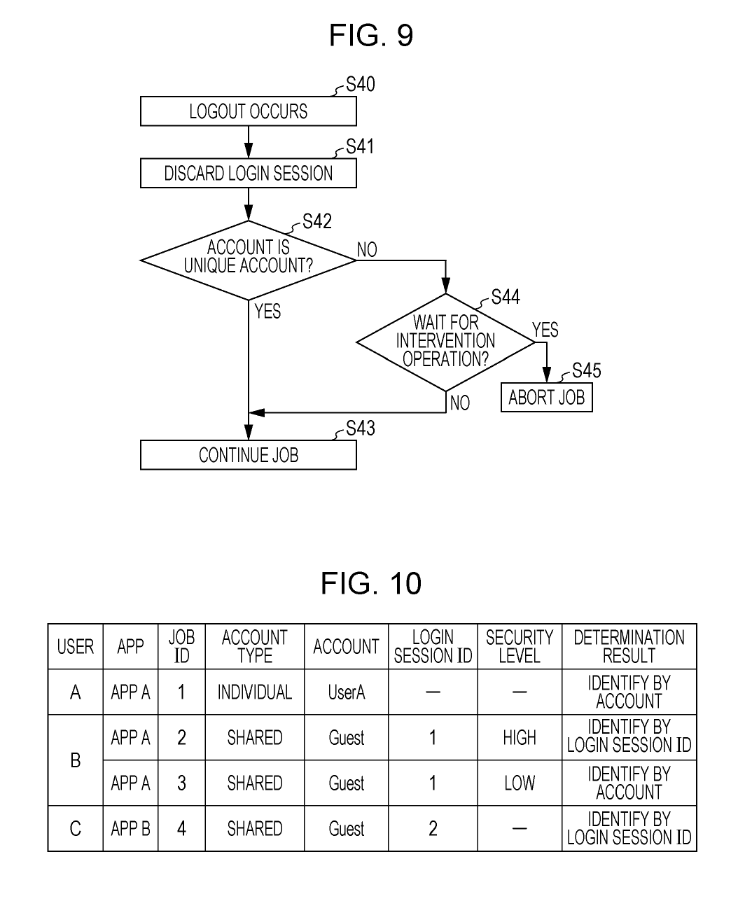

Hereinafter, a process when a login session becomes invalid will be described with reference to FIG. 9. FIG. 9 illustrates a flowchart illustrating such a process.

If a user logs out of the image forming device 10 (S40), the login session (login session ID) is discarded and becomes invalid (S41). The account type determination unit 28 references the account information included in the job information, and thereby determines the type of the account assigned to the user who specified the execution of the job (S42). If the account is a unique account (S42, Yes), the job execution unit 16 continues the job (S43). If the account is not a unique account (S42, No), or in other words, if the account is a shared account, the process proceeds to step S44. If an intervention event involving identification of the user by login session ID occurs, and the image forming device 10 is waiting for an intervention operation by the user (S44, Yes), the controller 22 aborts the jobs (S45). If the image forming device 10 is not waiting for an intervention operation by the user (S44, No), the job execution unit 16 continues the job (S43).

If an intervention event to be handled securely occurs, the user is identified by the login session ID rather than shared account information. If the intervention operation is not performed, and the login session ID becomes invalid while the image forming device 10 is waiting for an intervention operation, the person possessing the authority to perform operations on the job becomes unavailable. To address this situation, the login session becomes invalid, and in addition, if the image forming device 10 is waiting for an intervention operation, the job is aborted. As a result, the above problems are addressed.

As above, according to the present exemplary embodiment, even if shared account information is used, the user is identified by the login session ID. Consequently, individual users are distinguished and identified, and per-user control of operations on jobs or resulting data (access control) is realized. As a result, in cases in which unique account information is not used, a reduction in security may be avoided or minimized compared to the case of uniformly controlling user operations using shared account information.

Also, in the present exemplary embodiment, in cases in which shared account information is used, the user is identified by either the shared account information or the login session ID, depending on the security level of the application (job). If the security level of the application is relatively high, the user is identified by the login session ID. Consequently, individual users are distinguished and identified even in cases in which shared account information is used, and thus a reduction in security with respect to an application or result may be avoided or minimized compared to the case of identifying the user by the shared account information. On the other hand, if the security level of the application is relatively low, since there is little demand to distinguish and identify individual users, the user is identified by the shared account information. Consequently, in cases in which the security level of an application is relatively low, the convenience of operations on the application or result may be improved compared to the case of uniformly identifying the user by login session ID.

Also, in the present exemplary embodiment, in cases in which shared account information is used, the user is identified by either the shared account information or the login session ID, depending on the security level of the data that is the target of the job. For example, the security level for the data is decided by the user. If the security level of the data is relatively high, the user is identified by the login session ID. Consequently, individual users are distinguished and identified even in cases in which shared account information is used, and thus a reduction in security with respect to data may be avoided or minimized compared to the case of identifying the user by the shared account information. On the other hand, if the security level of the data is relatively low, since there is little demand to distinguish and identify individual users, the user is identified by the shared account information. Consequently, in cases in which the security level of data is relatively low, the convenience of operations on the data may be improved compared to the case of uniformly identifying the user by using the login session ID.

Also, in the present exemplary embodiment, in cases in which shared account information is used, the user is identified by either the shared account information or the login session ID, depending on the security level of the intervention operation. If the security level of the intervention operation is relatively high, the user is identified by the login session ID. Consequently, individual users are distinguished and identified even in cases in which shared account information is used, and thus a reduction in security with respect to an intervention operation may be avoided or minimized compared to the case of identifying the user by the shared account information. On the other hand, if the security level of the intervention operation is relatively low, since there is little demand to distinguish and identify individual users, the user is identified by the shared account information. Consequently, in cases in which the security level of the intervention operation is relatively low, the convenience of intervention operations may be improved compared to the case of uniformly identifying the user by the login session ID.

Hereinafter, specific examples of the present exemplary embodiment will be described.

### Specific Example 1

Hereinafter, a specific example 1 will be described with reference to FIG. 10. In FIG. 10, information such as the account type is summarized in a table.

In specific example 1, suppose that the execution of jobs (applications) are specified by each of users A, B, and C. The account type of User A is a unique account, and the ID of the unique account (unique account information) is “UserA”. The account type of Users B and C is a shared account, and the ID of the shared account (shared account information) is “Guest”.

In FIG. 10, “App” (Application) is the application to be executed.

Application A (App A) is an application for which secure handling or not is decided by a user specification. If the user selects Application A, a screen prompting the user about whether or not to handle the application securely is displayed on the UI unit 20 or the terminal device 12. If the user specifies a security level on the screen, security information indicating that security level is written to the job information.

Application B (App B) is an application that is handled securely.

In FIG. 10, Job ID is information for managing jobs.

The job with a job ID of “1” (Job 1) is a job whose execution is specified by User A possessing a unique account, and is a job for executing Application A. Since unique account information is used, the login session ID and security information are not written to the job information.

The job with a job ID of “2” (Job 2) is a job whose execution is specified by User B possessing a shared account, and is a job for executing Application A. User B logs in to the image forming device 10, and as a result, a login session is established, and a login session ID is generated. The login session ID is “1”. The login session ID “1” is written to the job information. Also, the security level of Application A is set to “high” by User B. Security information indicating the security level “high” is written to the job information.

The job with a job ID of “3” (Job 3) is a job whose execution is specified by User B possessing a shared account, and is a job for executing Application A. The login session ID is “1”. User B logs in to the image forming device 10, and as a result, the login session ID “1” is generated. User B specifies the execution of Jobs 2 and 3. The login session ID “1” is written to the job information. Also, the security level of Application A is set to “low” by User B. Security information indicating the security level “low” is written to the job information.

The job with a job ID of “4” (Job 4) is a job whose execution is specified by User C possessing a shared account, and is a job for executing Application B. User C logs in to the image forming device 10, and as a result, a login session is established, and a login session ID is generated. The login session ID is “2”. The login session ID “2” is written to the job information. Also, Application B is an application that is handled securely.

Since the execution of Job 1 is specified by User A possessing a unique account, User A is identified by the unique account information “UserA”. Consequently, only User A is allowed to perform operations on Job 1, thus ensuring the security of Job 1.

Since the execution of Job 2 is specified by User B possessing a shared account, and the security level is set to “high”, User B is identified by the login session ID “1”. Consequently, only User B is allowed to perform operations on Job 2, thus ensuring the security of Job 2.

Since the execution of Job 3 is specified by User B possessing a shared account, and the security level is set to “low”, User B is identified by the shared account information “Guest”. Since the user is identified by shared account information, any user possessing the shared account is allowed to perform operations on Job 3. Thus, not only User B but also User C is allowed to perform operations on Job 3. Consequently, the convenience of performing operations on Job 3 is ensured.

The execution of Job 4 is specified by User C possessing a shared account, and Application B to be handled securely is executed. For this reason, User C is identified by the login session ID “2”. Consequently, only User C is allowed to perform operations on Job 4, thus ensuring the security of Job 4.

### Specific Example 2

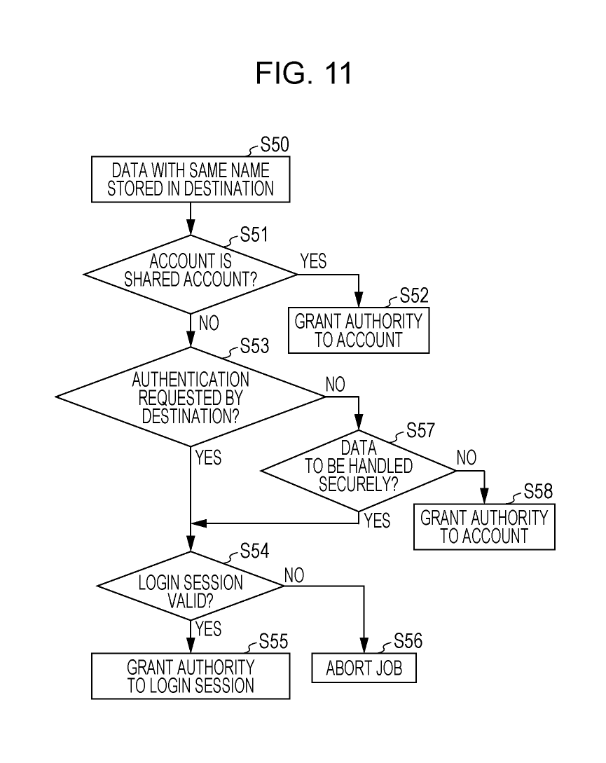

Hereinafter, a specific example 2 will be described with reference to FIG. 11. FIG. 11 illustrates a flowchart illustrating a process according to the specific example 2.

The job according to the specific example 2 is a job for generating resulting data by the execution of an application, and transferring and storing the resulting data to a designated storage location. The storage location is an external device other than the image forming device 10 (such as an external server), for example. Obviously, the resulting data may also be stored inside the image forming device 10. Hereinafter, the specific example 2 will be described in detail.

If data having the same data name as the data name of the resulting data is already being stored in the transfer destination (storage location) of the resulting data (S50), the account type determination unit 28 references the account information included in the job information to thereby determine the type of account of the user who specified the execution of the job (S51).

If the account of the user is a unique account (S51, Yes), the controller 22 grants operation authority to the user possessing the unique account (S52). Consequently, an intervention operation on the job is allowed.

An intervention operation to resolve the event in which data of the same name is already being stored may be any of the following operations, for example.
Overwrite the data.
Saving the resulting data with a different data name.
Aborting storage of the resulting data.
Storing the resulting data in another storage location (such as another server).

For example, an intervention operation screen for executing the above intervention operations is displayed on the UI unit 20 or the terminal device 12, and the user possessing the unique account performs an intervention operation on the intervention operation screen. The controller 22 conducts a process in accordance with the intervention operation.

If the account of the user is not a unique account (S51, No), or in other words, if the account is a shared account, it is determined whether or not authentication is requested by the transfer destination (such as an external server) (S53).

If authentication is requested by the transfer destination (S53, Yes), the validity of the login session ID included in the job information, or in other words, the validity of the login session associated with that login session ID, is determined (S54). If the login session associated with the login session ID is ongoing, the login session ID (login session) is valid, whereas if the user logs out of the image forming device 10, the login session ID (login session) becomes invalid. Note that the transfer destination requesting authentication may be a storage location assigned to each user, for example.

If the login session ID (login session) included in the job information is valid (S54, Yes), the controller 22 grants operation authority to the user to which the login session ID is associated (S55). Consequently, an operation on the job is allowed. For example, if the login state (login session) associated with the login session ID included in the job information is ongoing, and an intervention operation is performed while in that login state, the intervention operation is allowed.

If the login session ID (login session) included in the job information is invalid (S54, No), the controller 22 aborts the job (S56).

If the transfer destination does not request authentication (S53, No), the user identification unit 32 references the security information included in the job information, and thereby determines whether or not the resulting data to store is to be handled securely (S57). If the security level of the resulting data is low (S57, No), the controller 22 grants operation authority to the user possessing the shared account (S58). Consequently, an intervention operation on the job is allowed. If the security level of the resulting data is high (S57, Yes), the process proceeds to step S54.

In the case in which a shared account is being used, if users are uniformly identified by the shared account and an intervention operation is allowed, security with respect to the resulting data may be lowered in some cases. For example, if a storage location assigned to each user is selected as the transfer destination, to ensure security with respect to the resulting data or the storage location, it is undesirable for a user other than the user who specified the execution of the job to perform an intervention operation. In the specific example 2, when the transfer destination requests authentication, the user is identified by the login session ID. Consequently, a reduction in security with respect to the resulting data or the storage location may be avoided or minimized compared to the case of uniformly identifying users by the shared account information.

For example, in the case of uniformly identifying users by the shared account information, users other than the user who specified the execution of the job are granted operation authority, and thus incorrect operations or unauthorized operations may be performed. By identifying the user by the login session ID, such incorrect operations or unauthorized operations may be avoided.

On the other hand, the storage location assigned to each shared account may be a storage location who usage is granted to users possessing the shared account. In this case, if the user is identified by the login session ID, usage by users not associated with that login session ID is denied. To address this issue, when the transfer destination does not request authentication, the user is identified by the shared account information. Consequently, user convenience with respect to the resulting data and the storage location is improved compared to the case of uniformly identifying users by the login session ID.

In addition, if the data is to be handled securely, the user is identified by the login session ID. Consequently, a reduction in security with respect to the data may be avoided or minimized compared to the case of uniformly identifying users by the shared account information.

### Specific Example 3

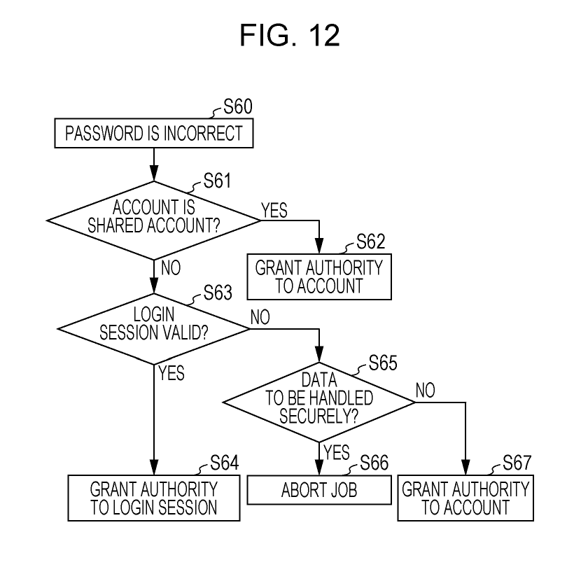

Hereinafter, a specific example 3 will be described with reference to FIG. 12. FIG. 12 illustrates a flowchart illustrating a process according to the specific example 3.

The job according to the specific example 3 is a job for generating resulting data by the execution of an application, and transferring and storing the resulting data to a designated storage location. The storage location is an external device other than the image forming device 10 (such as an external server), for example. Obviously, the resulting data may also be stored inside the image forming device 10. Hereinafter, the specific example 3 will be described in detail.

As an example, the case of transferring resulting data to an external server will be described. Suppose that the external server requires an authentication process to be used, and that a password is used in the authentication process. If a registered password is input, authentication is successful, and the transfer of resulting data to the external server is allowed.

When transferring resulting data to the external server, if the password for the external server is incorrect (S60), the account type determination unit 28 references the account information included in the job information to thereby determine the type of account of the user who specified the execution of the job (S61).

If the account of the user is a unique account (S61, Yes), the controller 22 grants operation authority to the user possessing the unique account (S62). Consequently, an intervention operation on the job is allowed.

An intervention operation to resolve the event of an incorrect password may be any of the following operations, for example.
Reentering the password.
Designating a different storage location.

For example, an intervention operation screen for executing the above intervention operations is displayed on the UI unit 20 or the terminal device 12, and the user possessing the unique account performs an intervention operation on the intervention operation screen. The controller 22 conducts a process in accordance with the intervention operation.

If the account of the user is not a unique account (S61, No), or in other words, if the account is a shared account, the validity of the login session ID included in the job information, or in other words, the validity of the login session, is determined (S63). If the login session is ongoing, the login session ID (login session) is valid, whereas if the user logs out of the image forming device 10, the login session ID (login session) becomes invalid.

If the login session ID (login session) included in the job information is valid (S63, Yes), the controller 22 grants operation authority to the user to which the login session ID is associated (S64). Consequently, an operation on the job is allowed. For example, if the login state (login session) associated with the login session ID included in the job information is ongoing, and an intervention operation is performed while in that login state, the intervention operation is allowed.

If the login session ID (login session) included in the job information is invalid (S63, No), the user identification unit 32 references the security information included in the job information, and thereby determines whether or not the resulting data to store is to be handled securely (S65). If the security level of the resulting data is high (S65, Yes), the controller 22 aborts the job (S66). If the security level of the resulting data is low (S65, No), the controller 22 grants operation authority to the user possessing the shared account (S67). Consequently, an intervention operation on the job is allowed. As another example, the resulting may also be stored in shared storage automatically.

Since the external server that demands a password is a storage location assigned to each individual user, to ensure security with respect to the resulting data or the storage location, it is undesirable for a user other than the user who specified the execution of the job to perform an intervention operation. In the case in which a shared account is being used, if users are uniformly identified by the shared account and an intervention operation is allowed, security with respect to the resulting data or the storage location may be lowered in some cases. In the specific example 3, the user is identified by the login session ID. Consequently, a reduction in security with respect to the resulting data or the storage location may be avoided or minimized compared to the case of uniformly identifying users by the shared account information.

In addition, in the specific example 3, if the login session is invalid and the data is not to be handled securely, operation authority is granted to users of the shared account. Consequently, user convenience with respect to the resulting data and the storage location is improved compared to the case of uniformly identifying users by the login session ID.

In the specific example 3, the order of the processing in step S63 and the processing in step S65 may be changed. In other words, the processing in step S63 may also be executed after the processing in step S65 is executed. If the data is not to be handled securely, operation authority is granted to users possessing the shared account. If the data is to be handled securely, and the login session is valid, operation authority is granted to the login session, whereas if the login session is invalid, the job is aborted.

### Specific Example 4

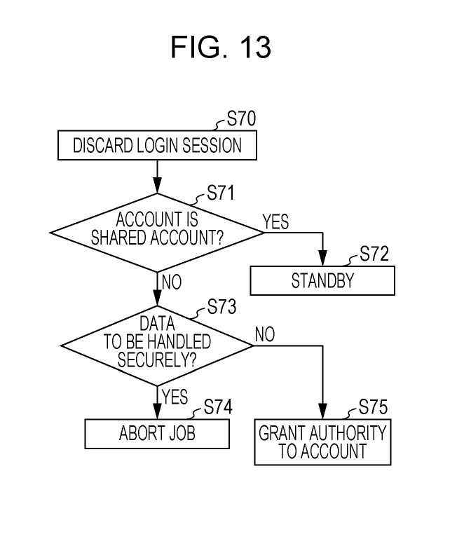

Hereinafter, a specific example 4 will be described with reference to FIG. 13. FIG. 13 illustrates a flowchart illustrating a process according to the specific example 4.

In the specific example 4, when an event according to the above specific example 3 (incorrect password) occurs, the user who specified the execution of the job logs out of the image forming device 10. Consequently, the login session becomes invalid.

When the user logs out of the image forming device 10, the login session (login session ID) is discarded and becomes invalid (S70). In this case, the account type determination unit 28 references the account information included in the job information, and thereby determines the type of the account of the user who specified the execution of the job (S71).

If the account of the user is a unique account (S71, Yes), the job enters a standby state (S72).

If the account of the user is not a unique account (S71, No), or in other words, if the account is a shared account, the user identification unit 32 references the security information included in the job information, and thereby determines whether or not the resulting data to store is to be handled securely (S73). If the security level of the resulting data is high (S73, Yes), the controller 22 aborts the job (S74). If the security level of the resulting data is low (S73, No), the controller 22 grants operation authority to the user possessing the shared account (S75). Consequently, an intervention operation on the job is allowed.

Note that the process may be changed between the case in which the login session becomes invalid after the intervention operation occurs, and the case in which the intervention operation occurs after the login session becomes invalid. If a user logs out after an intervention event occurs, that user may not have any intention of performing an intervention operation such as reentering a password. To address the above issue, the job may be aborted if the login session becomes invalid after an intervention event occurs.

Hereinafter, exemplary modifications will be described.

### Exemplary Modification 1

An exemplary modification 1 will be described. In the exemplary modification 1, the occurrence of an intervention event during the execution of a job is predicted, and the job is controlled on the basis of the prediction result. For example, suppose that as a result of a job being executed, various processes are executed, and then a print process is executed. Suppose that in the case in which a user with a shared account specifies the execution of such a job, an intervention event occurs, and the job is aborted if that user's login session is invalid. An intervention event occurs partway through the print process if the number of pages to print as set in the job is greater than an upper-limit value on the number of sheets of paper loaded into the image forming device 10. The controller 22 references the job information, and thereby specifies the number of pages to be printed by the job. If the number of pages is greater than the upper-limit value, an intervention event is predicted to occur. The print process itself is a process that does not have to be handled securely. Consequently, if a user with a shared account specifies the execution of a job, and a predicted intervention event occurs, the controller 22 does not abort the job even if the login session is invalid, and instead puts the job in standby so the job may be continued after an intervention operation by the user. For example, the job is resumed after paper is resupplied. In this way, when an intervention event is predicted to occur partway through a process that does not have to be handled securely, the job may be continued without being aborted.

### Exemplary Modification 2

An exemplary modification 2 will be described. A job may be resumed even if the login session is invalid when the intervention event occurs. For example, the controller 22 may issue a password when a user with a shared account specifies the execution of a job. The password is associated with the job. The password is displayed on the UI unit 20 or the terminal device 12, for example. If the login session is invalid when an intervention event occurs during the execution of the job, the controller 22 grants operation authority to the user with the shared account. In this case, an intervention operation screen is displayed on the UI unit 20 or the terminal device 12. The intervention operation screen includes a password input field, and the user performs an intervention operation after first inputting the password. Note that the job may also be aborted by the user. If the login session is valid, operation authority is granted to the login session.

According to the exemplary modification 2, even if a shared account is used to specify the execution of a job, a password is issued, and thus the authority to perform an intervention operation is granted to only the user who specified the execution of the job. For example, even if the login session becomes invalid during the execution of a job to be handled securely, and an intervention operation occurs later, the job may be continued while also ensuring the security of the job.

Note that the job may also be continued by a process other than a password-based process. For example, if the execution of the job is specified from the terminal device 12, the terminal device 12 and the job may be associated together, and an intervention operation may be allowed from that terminal device 12. As another example, if the execution of a job is specified from the terminal device 12, a cookie and the job may be associated together, and an intervention operation may be allowed from that terminal device 12. As yet another example, if a job for storing resulting data on an external server is being executed, the authentication information of that external server and the job may be associated together. If authentication using the authentication information is successful, an intervention operation may be allowed.

The above image forming device 10 is realized by the cooperative action of hardware resources and software as an example. Specifically, the image forming device 10 is equipped with a processor such as a CPU (not illustrated). By having the processor load and execute a program stored in a storage device (not illustrated), the functions of the respective components of the image forming device 10 are realized. The program is stored in the storage device via a recording medium such as a CD or DVD, or alternatively, via a communication link such as a network. Alternatively, the components of the image forming device 10 may also be realized by hardware resources such as a processor or an electronic circuit, for example. A device such as memory may also be used in such a realization. As another example, the components of the image forming device 10 may also be realized by a digital signal processor (DSP), a field-programmable gate array (FPGA), or the like. Note that an information processing device according to an exemplary embodiment of the invention is not limited to the image forming device 10, and may also be a computer of typical configuration capable of executing jobs on the basis of instructions from the user.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing device comprising a processor specifically configured to:
execute a process;
generate, in response to a login request from a user, login session information that becomes invalid if the user logs out;
if user identification information assigned to the user who specified the execution of the process is unique user identification information that is unique to the user, control a user operation on the process with the unique user identification information; and
if the user identification information assigned to the user who specified the execution of the process is shared user identification information that is shared among a plurality of users, control the user operation on the process with the login session information.

2. The information processing device according to claim 1, wherein
if the user identification information assigned to the user who specified the execution of the process is the shared user identification information, the processor controls the user operation on the process with either the shared user identification information or the login session information, depending on a security level related to the process.

3. The information processing device according to claim 2, wherein
if the user identification information assigned to the user who specified the execution of the process is the shared user identification information, the processor controls the user operation on the process with either the shared user identification information or the login session information, depending on a security level of data that is a target of the process.

4. The information processing device according to claim 1, wherein
if the user identification information assigned to the user who specified the execution of the process is the shared user identification information, and in addition, the process stops during execution, the processor controls the user operation on the process with either the shared user identification information or the login session information, depending on a reason for the stop.

5. The information processing device according to claim 1, wherein
in a case of controlling the user operation with the login session information, if the login session information is invalid, the processor aborts the execution of the process.

6. The information processing device according to claim 5, wherein
in a case of the process stopping during execution, if a security level of the stopped process is equal to or greater than a threshold value, and the login session information is invalid, the processor aborts the execution of the process, whereas if the security level of the stopped process is less than the threshold value, the processor continues the execution of the process.

7. An information processing method comprising:
executing a process;
generating, in response to a login request from a user, login session information that becomes invalid if the user logs out; and
controlling, if user identification information assigned to the user who specified the execution of the process is unique user identification information that is unique to the user, a user operation on the process with the unique user identification information, and if the user identification information assigned to the user who specified the execution of the process is shared user identification information that is shared among a plurality of users, controlling the user operation on the process with the login session information.

8. A non-transitory computer readable medium storing a program causing a computer to execute a process for processing information, the process comprising:
executing a process;
generating, in response to a login request from a user, login session information that becomes invalid if the user logs out; and
controlling, if user identification information assigned to the user who specified the execution of the process is unique user identification information that is unique to the user, a user operation on the process with the unique user identification information, and if the user identification information assigned to the user who specified the execution of the process is shared user identification information that is shared among a plurality of users, controlling the user operation on the process with the login session information.

9. The information processing device according to claim 1, wherein the processor determines whether the user identification information is unique or shared.

10. The information processing device according to claim 1, wherein the user identification information is input as part of the login request.
